(19) United States
(12) Patent Application Publication
(10) Pub. No.: US 2024/0305517 A1
(43) Pub. Date: Sep. 12, 2024

(54) INTENT BASED AUTOMATION SYSTEM

(71) Applicant: NetBrain Technologies, Inc., Burlington, MA (US)

(72) Inventors: Lingping Gao, Burlington, MA (US); Peng Zhao, Burlington, MA (US); Xu Zhao, Burlington, MA (US); Long Zeng, Burlington, MA (US); Xufei Cheng, Burlington, MA (US); Zhongxi Yuan, Burlington, MA (US); Guangdong Liao, Burlington, MA (US)

(73) Assignee: NetBrain Technologies, Inc., Burlington, MA (US)

(21) Appl. No.: 18/540,292

(22) Filed: Dec. 14, 2023

Related U.S. Application Data
(63) Continuation-in-part of application No. 18/172,061, filed on Feb. 21, 2023.
(63) Continuation-in-part of application No. 18/172,044, filed on Feb. 21, 2023.
(63) Continuation-in-part of application No. 17/729,275, filed on Apr. 26, 2022.
(63) Continuation-in-part of application No. 17/729,182, filed on Apr. 26, 2022.
Application No. 18/172,044 is a continuation-in-part of application No. 17/729,182, filed on Apr. 26, 2022.
Application No. 17/729,182 is a continuation-in-part of application No. 17/729,275, filed on Apr. 26, 2022.
Application No. 18/172,061 is a continuation-in-part of application No. 17/729,182, filed on Apr. 26, 2022.
Application No. 17/729,182 is a continuation-in-part of application No. 17/729,275, filed on Apr. 26, 2022.
(60) Provisional application No. 63/486,149, filed on Feb. 21, 2023.
(60) Provisional application No. 63/311,679, filed on Feb. 18, 2022.
(60) Provisional application No. 63/311,679, filed on Feb. 18, 2022.
(60) Provisional application No. 63/179,782, filed on Apr. 26, 2021.
(60) Provisional application No. 63/179,782, filed on Apr. 26, 2021.

(51) Int. Cl. H04L 41/0604; H04L 41/0631

(52) U.S. Cl. CPC H04L 41/0604; H04L 41/0631

(57) ABSTRACT

Intent Template (NIT) simplifies the Intent's replication. Users can define NIT for any network intent (NI) with the single-device diagnosis by setting the device qualifications and the critical variables to be auto-tested. The Intent with the template configured can be cloned on the fly after it is decoded and installed in the Intent Library, which may be the central console to install Intent and NIT in the Problem Diagnosis Automation System (PDAS) system: enable the backend decoding service to qualify the devices against the template setting; update the baseline data; enable the auto intent to create the intents in the map (Auto Intent for the IAF); install the Intent in TAF and PAF; execute the configure orchestration files downloaded from NetBrain KC to download and install the intents automatically.

### PRIORITY

This application claims priority to Provisional Patent Application No. 63/486,149, filed on Feb. 21, 2023, entitled INTENT BASED AUTOMATION SYSTEM, the entire disclosure of which is herein incorporated by reference.

This application claims priority as a continuation-in-part to U.S. application Ser. No. 18/172,061, filed Feb. 21, 2023, entitled TRIGGERED AUTOMATION FRAMEWORK, and U.S. application Ser. No. 18/172,044, filed Feb. 21, 2023, entitled NETWORK INTENT CLUSTER, each of which claims priority to Provisional Patent Application No. 63/311,679, filed on Feb. 18, 2022, entitled PROBLEM DIAGNOSIS AUTOMATION SYSTEM (PDAS) INCLUDING NETWORK INTENT CLUSTER (NIC), TRIGGERED DIAGNOSIS, AND PERSONAL MAP, and each of which claims priority as a continuation-in-part to U.S. application Ser. No. 17/729,275, filed on Apr. 26, 2022, entitled NETWORK ADAPTIVE MONITORING, and to U.S. application Ser. No. 17/729,182, filed on Apr. 26, 2022, entitled NETWORK INTENT MANAGEMENT AND AUTOMATION, both of which claim priority to Provisional Patent Application No. 63/179,782, filed on Apr. 26, 2021, entitled INTENT-BASED NETWORK AUTOMATION, the entire disclosures of each are herein incorporated by reference.

This application claims priority as continuation-in-part to U.S. application Ser. No. 17/729,275, filed on Apr. 26, 2022, entitled NETWORK ADAPTIVE MONITORING, and to U.S. application Ser. No. 17/729,182, filed on Apr. 26, 2022, entitled NETWORK INTENT MANAGEMENT AND AUTOMATION, both of which claim priority to Provisional Patent Application No. 63/179,782, filed on Apr. 26, 2021, entitled INTENT-BASED NETWORK AUTOMATION, the entire disclosures of each are herein incorporated by reference.

### BACKGROUND

In the modern computer age, businesses rely on an electronic network to function properly. Computer network management and troubleshooting are complex. There are thousands of shell scripts and applications for different network problems. The available, but poorly documented solutions can be overwhelming for junior network engineers. Most network engineers learn troubleshooting through reading the manufacturer's manual or internal documentation from the company's documentation department. But the effectiveness varies. For instance, the troubleshooting knowledge captured in a document can only be helpful if the information is accurate and the user correctly identifies the problem. Many companies have to conduct extensive training for junior engineers. The conventional way of network troubleshooting requires a network professional to manually run a set of standard commands and processes for each device. However, to become familiar with those commands, along with each of their parameters, takes years of practice. Also, complicated troubleshooting methodology is often hard to share and transfer. Therefore, even though a similar network problem happens repeatedly, each troubleshooting instance may still have to start from scratch. However, networks are getting more and more complex, and it is increasingly difficult to manage them efficiently with traditional methods and tools.

Network management teams provide two functions: to deliver services required by the business and to ensure minimized downtime. The first function may be dominated by projects, such as data centers, cloud migration, or implementing quality of service (QoS) for a voice or video service. The second function, minimizing downtime, may be more critical in impacting a company's revenue and reputation. Ensuring minimal downtime can include preventing outages from happening and resolving outages as soon as possible. Two measurements for an outage may include Mean Time Between Failure (MTBF) and Mean Time to Repair (MTTR).

Network management may utilize new methodologies and processes to accommodate the global shift to digital technologies. To manage the network efficiently with tactical, manual approaches using legacy mechanisms to build, operate, and troubleshoot may need to improve.

### SUMMARY

This disclosure generally relates to Problem Diagnosis Automation System (PDAS) for network management automation using network intent (NI). Network intent (NI) represents a network design and baseline configuration for that network or network devices with the ability to diagnose deviation from the baseline configuration. Problem Diagnosis Automation System (PDAS) automates the diagnosis of repetitive problems and the enforcement of preventive measures across a network. Automation assets across the network include Network Intent (NI) or Executable Runbook (RB) inside the no-code platform. Automation is executed in response to an external symptom in three successive methods, namely interactive, triggered, and preventive. Execution output is organized inside an incident pane for each incident. A Network Intent Cluster (NIC) clones an NI across the network to create a group of NIs (member NIs) with the same design or logic. NIC may be created from a seed NI via no coding process. In PDAS, a subset of Member NIs can be automatically executed according to the user-defined condition based on the member device, the member NI tags, or signature variables. A Triggered Automation Framework (TAF) matches the incoming API calls from a 3rd party system to current incidents and installs the automation (e.g., NI/NIC) to be triggered for each call. It may include an integrated IT System defining the scope and data of the incoming API calls; Incident Type to match a call to an Incident; and Triggered Diagnosis to define what and how the NIC/NI is executed.

Network Intent Template (NIT) may simplify the intent's replication as described herein. Users may define NIT for any network intent (NI) with the single-device diagnosis by setting the device qualifications and the critical variables to be auto-tested. The Intent with the template configured may be cloned on the fly after it is decoded and installed in the Intent Library. The intent library is the central console to install Intent and NIT in the PDAS system. It may enable the backend decoding service to qualify the devices against the template setting, update the baseline data, enable the auto intent to create the intents in the map (e.g., Auto Intent for the IAF), install the Intent in TAF and PAF, and execute the configure orchestration files downloaded and then for installing the intents automatically.

In one embodiment, a method for network intent replication includes defining an intent template comprising criteria for qualifying devices; enabling a backend decoding service for the qualifying devices compared with the intent template; updating baseline data based on the backend decoding service; and creating and executing intents for the qualified devices in a map. The intent template is configured for defining the qualifying devices; filtering the defined devices by device group or groups; defining critical variable settings based on a selection of diagnosis variables; or defining, depending on network intent (NI), macro variables.

In one embodiment, a system includes an intent template configured to qualify devices; a backend decoding service configured to qualify the devices based on the intent template and to update baseline data; and creating and executing intents for the qualified devices in a map. The intent template includes: definitions of the devices that qualify; a filter for the defined devices by device group or sites; critical variable settings for the selection of diagnosis variables; macro variables for network intent (NI); and a reference map creation.

In one embodiment, a method for a triggered automation (TAF) includes: receiving API calls from a third party system or a self-service application; classifying the calls to an Incident Type; matching a standalone network intent (NI) or an intent template (NIT) with a data field of the API call; executing NIs to create a map or run a diagnosis; and outputting the maps and diagnosis results to an Incident Portal.

### BRIEF DESCRIPTION OF THE DRAWINGS

The system and method may be better understood with reference to the following drawings and descriptions. Non-limiting and non-exhaustive embodiments are described with reference to the following drawings. The components in the drawings are not necessarily to scale, emphasis instead being placed upon illustrating the principles of the invention. The drawings, like referenced numerals, designate corresponding parts throughout the different views.

FIG. 1 illustrates a block diagram of an example network system.

FIG. 2 illustrates the input and output of Problem Diagnosis Automation System (PDAS).

FIG. 3 illustrates a flow of Problem Diagnosis Automation System (PDAS).

FIG. 4 illustrates an example of Network Intent Template (NIT) creation.

FIG. 5 illustrates an option for neighbor pair replication.

FIG. 6 illustrates configuration for neighbor pair replication.

FIG. 7 illustrates replication of intent for neighbor devices.

FIG. 8 illustrates an example intent library process.

FIG. 9 illustrates an example console for intent installation.

FIG. 10 illustrates the configuration of intent timers.

FIG. 11 illustrates addition of intent.

FIG. 12 illustrates a selection of the intent.

FIG. 13 illustrates the configuration definition with an intent details pane.

FIG. 14 illustrates an example of intent decoding settings.

FIG. 15 illustrates an example of intent timer settings.

FIG. 16 illustrates an example of auto intent settings.

FIG. 17 illustrates an example of a post-execution diagnosis tree.

FIG. 18 illustrates an example view of the map.

FIG. 19 illustrates the scaling of auto intent.

FIG. 20 illustrates an example Triggered Automation Framework (TAF) framework.

FIG. 21 illustrates an example Triggered Automation Framework (TAF) process.

FIG. 22 illustrates an example intent library interface.

FIG. 23 illustrates an example Preventative Automation Framework (PAF) process.

FIG. 24 illustrates an example of intent timer configuration for preventative automation.

FIG. 25 illustrates an example interface for probe triggering.

### DETAILED DESCRIPTION

Network problems may be organized by a Ticket System in the form of incidents. Those network problems may be repetitive: identical or similar problems happen repeatedly but are diagnosed the same way each time. Often those problems are preventable, caused by misconfiguration, performance degradation, or security violations. However, a lack of automated methods to enforce the design rules, best practices, or security policy may prevent the remediation of those problems effectively.

Problem Diagnosis Automation System (PDAS) may address those issues. Specifically, PDAS may include automating the Diagnosis of the repetitive problem and automating the enforcement of preventive measures across the entire network. PDAS automates the Diagnosis of repetitive problems and enforces preventive measures across the entire network.

The PDAS system may be built on Network Intent as described in U.S. Pat. Pub. No. 2022/0393942 with network intent templates, the entire disclosure is incorporated by reference. The PDAS system may further include a Network Intent Cluster as described in the U.S. application Ser. No. 18/172,044, which is herein incorporated by reference. There may be a Triggered Automation Framework described in U.S. Pat. Pub. No. 2023/0198866. There may be monitoring of adaptive networking as described in U.S. Pat. Pub. No. 2022/0360509, which is incorporated by reference.

The Intent-based Problem Diagnosis Automation System (PDAS) may be improved for the flow of building a PDAS system on a large scale by using a Network Intent Template (NIT).

Network Intent Template (NIT) may simplify the intent's replication as described herein. Users may define NIT for any network intent (NI) with the single-device diagnosis by setting the device qualifications and the critical variables to be auto-tested. The Intent with the template configured may be cloned on the fly after it is decoded and installed in the Intent Library. The intent library is the central console to install Intent and NIT in the PDAS system. It may enable the backend decoding service to qualify the devices against the template setting, update the baseline data, enable the auto intent to create the intents in the map (e.g., Auto Intent for the IAF), install the Intent in TAF and PAF, and execute the configure orchestration files downloaded and then for installing the intents automatically.

A Triggered Automation Framework (TAF) matches the incoming API calls from a 3rd party system to current incidents and installs the automation (e.g., network intent or network intent clusters) to be triggered for each call. It may include an Integrated IT System defining the scope and data of the incoming API calls, an Incident Type to match a call to an Incident, and a Triggered Diagnosis to define the execution of the network intent or network intent clusters.

Network intent clusters (NIC) expand Network Intent (NI) scope from a specific network design to one type of network design with similar diagnosis logic. A large network can have millions of NIs, and it may be time-consuming to add these NIs manually. The NIC system can discover and create these NIs automatically. While NI effectively documents and validates a network design, it may apply to at least one network device or a set of devices at a time. Therefore, it can take many repetitive efforts to create NIs for a large network. NIC may be designed to expand the logic of a NI (seed NI) from one or a set of devices to the whole network. Furthermore, NIC may be triggered to run in the Triggered Automation Framework (TAF), and its results can significantly reduce the MTTR. NIC may not require coding skills and provides an intuitive user interface for creating and debugging. For example, a NI may monitor whether a failover occurs between a pair of network devices (the failover may cause performance issues such as slow applications). Upon identification, NIC can replicate the logic to all other pairs of network devices in the network without any coding.

Reference will now be made in detail to exemplary embodiments of the invention, examples of which are illustrated in the accompanying drawings. When appropriate, the same reference numbers are used throughout the drawings to refer to the same or like parts. The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, and some areas or elements may be expanded to help improve understanding of embodiments of the invention.

The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present disclosure, and that the detailed description is not to be taken in a limiting sense, and that elements may be differently positioned, or otherwise noted as in the appended claims without requirements of the written description being required thereto.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The aspects of the present disclosure may be described herein in terms of functional block components and various processing steps. It should be appreciated that such functional blocks may be realized by any number of hardware and/or software components configured to perform the specified functions. For example, these aspects may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting languages such as C, C++, Java, COBOL, assembler, PERL, Python, or the like, with the various algorithms being implemented with any combination of data structures, objects, processes, routines, or other programming elements. Further, it should be noted that the present disclosure may employ any number of conventional techniques for data transmission, signaling, data processing, network control, and the like.

The particular implementations shown and described herein are for explanatory purposes and are not intended to otherwise be limiting in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the disclosure.

As will be appreciated by one of ordinary skill in the art, aspects of the present disclosure may be embodied as a method or a system. Furthermore, these aspects of the present disclosure may take the form of a computer program product on a tangible computer-readable storage medium having computer-readable program-code embodied in the storage medium. Any suitable computer-readable storage medium may be utilized, including hard disks, CD-ROM, optical storage devices, magnetic storage devices, and/or the like. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

As used herein, the terms “user,” “network engineer,” “network manager,” “network developer” and “participant” shall interchangeably refer to any person, entity, organization, machine, hardware, software, or business that accesses and uses the system of the disclosure. Participants in the system may interact with one another either online or offline.

Communication between participants in the system of the present disclosure is accomplished through any suitable communication means, such as, for example, a telephone network, intranet, Internet, extranet, WAN, LAN, personal digital assistant, cellular phone, online communications, off-line communications, wireless network communications, satellite communications, and/or the like. One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like.

In network troubleshooting, a network engineer may use a set of commands, methods, and tools, either standard or proprietary. For example, these commands, methods, and tools may include the following items:

The Command Line Interface (CLI): network devices often provide CLI commands to check the network status or statistics. For example, in a Cisco IOS switch, the command “show interface” can be used to show the interface status, such as input errors.

Configuration management: a tool used to find differences of configurations of network devices in a certain period. This is important since about half of the network problems are caused by configuration changes.

The term “Object” refers to the term used in computer technology, in the same meaning as “object oriented” programming languages (such as Java, Common Lisp, Python, C++, Objective-C, Smalltalk, Delphi, Java, Swift, C#, Perl, Ruby, and PHP). It is an abstracting computer logic entity that envelops or mimics an entity in the real physical world, usually possessing an interface, data properties and/or methods.

The term “Device” refers to a data object representing a physical computer machine (e.g., printer, router) connected in a network or an object (e.g., computer instances or database instances on a server) created by computer logic functioning in a computer network.

The term “Q-map” or “Qmap” refers to a map of network devices created by the computer technology of NetBrain Technologies, Inc. that uses visual images and graphic drawings to represent the topology of a computer network with interface property and device property displays through a graphical user interface (GUI). Typically, a computer network is created with a map-like structure where a device is represented with a device image and is linked with other devices through straight lines, pointed lines, dashed lines and/or curved lines, depending on their interfaces and connection relationship. Along the lines, also displayed are the various data properties of the device or connection.

The term “Qapp” refers to a built-in or user-defined independently executable script or procedure generated through a graphical user interface as per technology available from NETBRAIN TECHNOLOGIES, INC.

The term “GUI” refers to a graphical user interface and includes a visual paradigm that offers users a plethora of choices. GUI paradigm or operation relies on windows, icons, mouse, pointers, and scrollbars to display the set of available files and applications graphically. In a GUI-based system, a network structure may be represented with graphic features (icons, lines and menus) that represent corresponding features in a physical network in a map. The map system may be referred to as a Qmap and is further described with respect to U.S. Pat. Nos. 8,386,593, 8,325,720, and 8,386,937, the entire disclosure of each of which is hereby incorporated by reference. After a procedure is created, it can be run in connection with any network system. Troubleshooting with a proposed solution may just take a few minutes instead of hours or days traditionally. The troubleshooting and network management automation may be with the mapping of the network along with the NETBRAIN QAPP (Qapp) system. The Qapp system is further described with respect to U.S. Pat. Nos. 9,374,278, 9,438,481, U.S. Pat. Pub. No. 2015/0156077, U.S. Pat. Pub. No. 2016/0359687, and U.S. Pat. Pub. No. 2016/0359688, the entire disclosure of each of which is hereby incorporated by reference.

The term “Step” refers to a single independently executable computer action represented by a GUI element, that obtains, or causes, a network result from, or in, a computer network; a Step can take a form of a Qapp, a system function, or a block of plain text describing an external action to be executed manually by a user, such as a suggestion of action, “go check the cable.” Each Step is thus operable and re-usable by a GUI operation, such as mouse curser drag-and-drop or a mouse click.

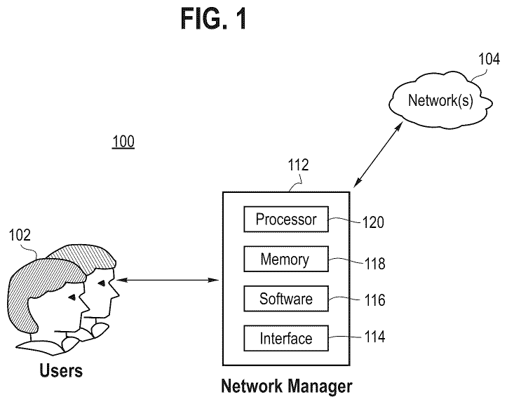

FIG. 1 illustrates a block diagram of an example network system 100. The system 100 may include functionality for managing network devices with a network manager 112. The network system 100 may include one or more networks 104, which includes any number of network devices (not shown) that are managed. The network(s) 104 devices may be any computing or network device, which belongs to network 104, such as a data center or enterprise network. Examples of devices include, but are not limited to, routers, access points, databases, printers, mobile devices, personal computers, personal digital assistants (“PDA”), cellular phones, tablets, other electronic devices, or any network devices. The devices in the network 104 may be managed by the network manager 112.

The network manager 112 may be a computing device for monitoring or managing devices in a network, including performing automation tasks for the management, including network intent analysis and adaptive monitoring automation. In other embodiments, the network manager 112 may be referred to as a network intent analyzer or adaptive monitor for a user 102. The network manager 112 may include a processor 120, a memory 118, software 116 and a user interface 114. In alternative embodiments, the network manager 112 may be multiple devices to provide different functions, and it may or may not include all of the user interface 114, the software 116, the memory 118, and/or the processor 120.

The user interface 114 may be a user input device or a display. The user interface 114 may include a keyboard, keypad, or cursor control device, such as a mouse, joystick, touch screen display, remote control, or any other device operative to allow a user or administrator to interact with the network manager 112. The user interface 114 may communicate with any of the network devices in the network 104, and/or the network manager 112. The user interface 114 may include a user interface configured to allow a user and/or an administrator to interact with any of the components of the network manager 112. The user interface 114 may include a display coupled with the processor 120 and configured to display output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the network manager 112 may include a central processing unit (CPU), a graphics processing unit (GPU), a digital signal processor (DSP), or other types of processing devices. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program (i.e., software 116), such as code generated manually (i.e., programmed). The software 116 may include the Data View system and tasks that are performed as part of the management of the network 104, including the generation and usage of Data View functionality. Specifically, the Data View may be implemented from software, such as the software 116.

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the software 116 or the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. The user interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly, as discussed below. Likewise, the connections with other components of the system 100 may be physical connections or may be established wirelessly.

Any of the components in the system 100 may be coupled with one another through a (computer) network, including but not limited to one or more network(s) 104. For example, the network manager 112 may be coupled with the devices in the network 104 through a network or the network manager 112 may be a part of the network 104. Accordingly, any of the components in the system 100 may include communication ports configured to connect with a network. The network or networks that may connect any of the components in the system 100 to enable data communication between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

The network manager 112 may act as the operating system (OS) of the entire network 104. The network manager 112 provides automation for the users 102, including automated documentation, automated troubleshooting, automated change, and automated network defense. In one embodiment, the users 102 may refer to network engineers who have a basic understanding of networking technologies, are skilled in operating a network via a device command line interface, and are able to interpret a CLI output. The users 102 may rely on the network manager 112 for controlling the network 104, such as with network intent analysis functionality or for adaptive monitoring automation.

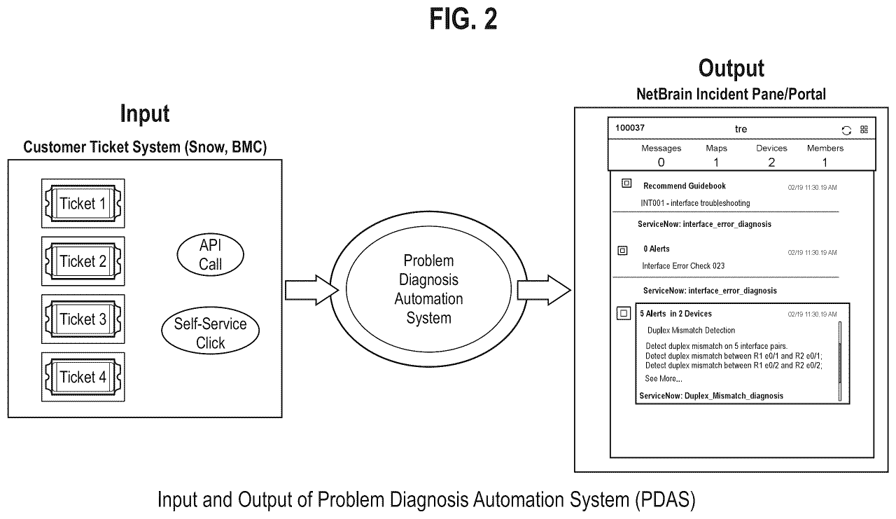

FIG. 2 illustrates the input and output of Problem Diagnosis Automation System (PDAS). PDAS may include automating the Diagnosis of the repetitive problem and automating the enforcement of preventive measures across the entire network. PDAS automates the Diagnosis of repetitive problems and enforces preventive measures across the entire network. FIG. 2 shows, from the end user's perspective, the output of PDAs is an Incident Pane/Portal, a central collaboration platform for troubleshooting and data sharing for each problem. The input is various tickets provided by customers indicating a network problem/issue. The Network Manager 112 from FIG. 1 may be the PDAS system.

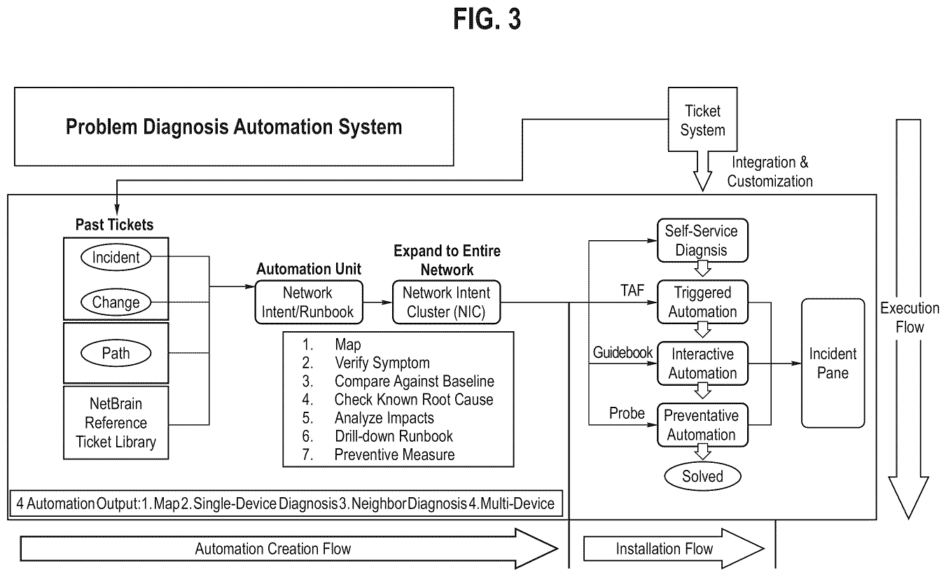

FIG. 3 illustrates a flow of Problem Diagnosis Automation System (PDAS). In one embodiment, the underlying system may have multiple example flows, including:
Automation Creation Flow: where diagnosis know-how is turned into automation assets across the entire network in the form of Network Intent (NI) or Executable Runbook (RB) inside the no-code platform.
Automation Installation Flow: where various automation assets are connected to future problem diagnosis through Triggers from the ticket system, human interaction, or an adaptive monitoring system.
Automation Execution Flow—where automation is executed in response to an external symptom in three successive methods, namely triggered, interactive, and preventive. All execution output is organized inside the NetBrain incident pane for each distinctive Incident.

Along with the flows in FIG. 2, the following functions may be included:
Network Intent Cluster (NIC): NIC may clone a Network Intent (NI), a seed NI, across the entire network to create a group of NIs (member NIs) with the same design or logic. NIC may be created from the seed NI. In PDAS, a subset of Member NIs may be automatically executed according to the user-defined condition based on the member device, the member NI tags, or signature variables.
Triggered Automation Framework (TAF): TAF may match incoming API calls from a 3rd party system to the Incidents and install the automation (NI/NIC) to be triggered for each call. In some embodiments, it has three components: an Integrated IT System defining the scope and data of the incoming API calls, an Incident Type to match a call to an Incident, and a Triggered Diagnosis to define what and how the NIC/NI is executed.
Incident Pane: as the output of PDAS, Incident Pane provides detailed data and diagnosis history, including NI diagnosis results (from TAF, Probe, manually run), the status codes of Adaptive Monitoring data, and recommended diagnoses.

### Network Intent Template

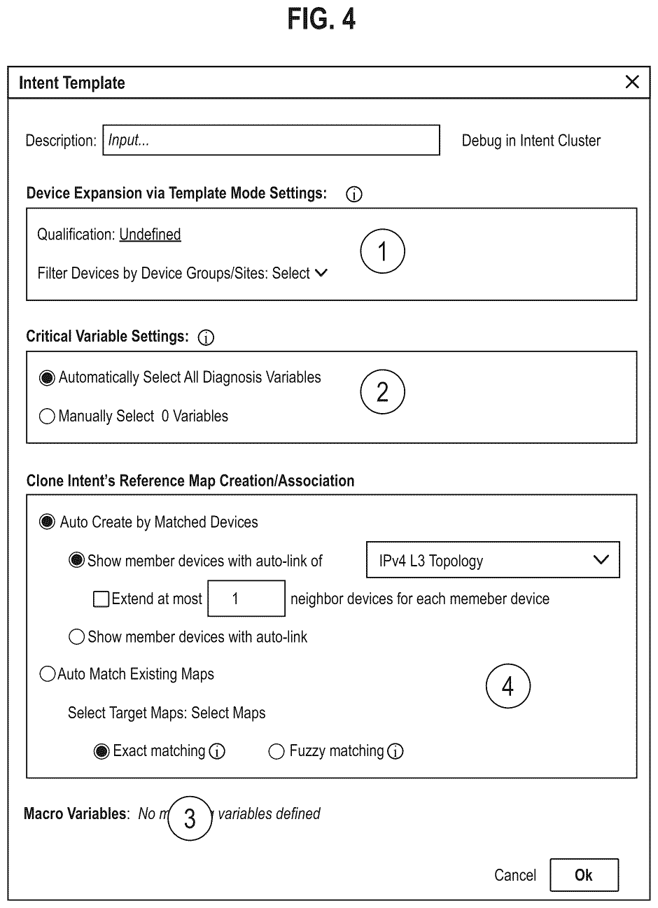

FIG. 4 illustrates an example of Network Intent Template (NIT) creation. In the first box, the filtering of devices is selected. For example, the qualified devices are defined, for example, Cisco IOS devices with OSPF configuration. This interface can also be used to filter devices by device group or sites. In the second box, critical variable settings are defined. The system selects all diagnosis variables by default. There is an option to manually select a set or a subset of the variables. A member network intent (NI) may be created for a device if all critical variables are retrieved and parsed successfully. In a third box, macro variables can be defined. In the fourth box, the reference map is created. After the NIT is defined, it can be installed and used throughout the system. A user can instruct the system to decode the Intent, a process to decide whether the system can create the member NI based on the template definition. Then, a user can enable the Intent to be displayed in the map under the Auto Intent. It can then be installed in TAF so that it can be triggered and may be installed in PAF so that a probe can trigger it.

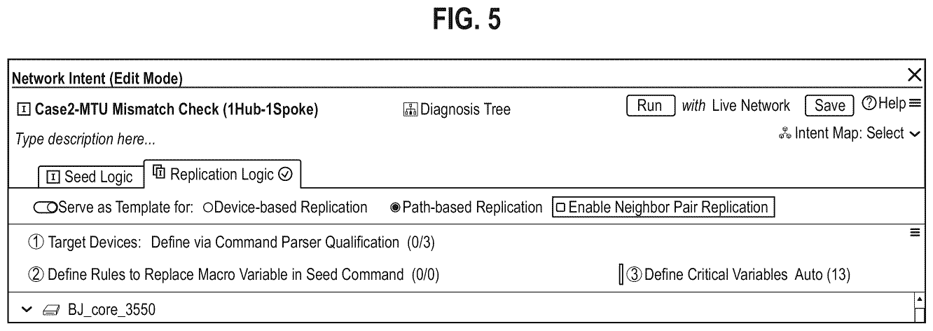

FIG. 5 illustrates an option for neighbor pair replication. Besides replicating an intent across the devices, the intent can also be replicated along an application path. The system may try replicating the seed intent for all devices along this path. If an intent has the diagnosis across the devices (such as checking the MTU mismatch of neighbor interfaces), the system can replicate the intent for the neighbor pairs.

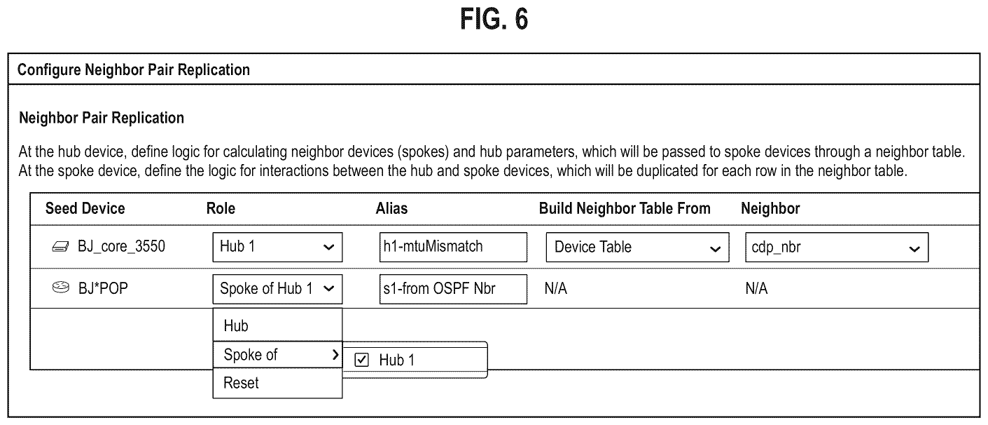

FIG. 6 illustrates configuration for neighbor pair replication. The NIT neighbor replication logic may include a device role and a neighbor table. The device role may include devices within the seed intent that can be defined as a hub device role or a spoke device role. At the hub device, there may be defined logic for calculating neighbor devices (spokes) and hub parameters, which will be passed to spoke devices through a neighbor table. At the spoke device, there may be defined logic for the interactions between the hub and spoke devices, which will be duplicated for each row in the neighbor table. The neighbor tables are used to discover the neighbor devices for the hub and optionally pass parameters that can be used for spoke devices. Users may need to assign a role for each seed device first. They can manually define which is the hub device and which is the spoke device and the dependency relationship between. For each hub device, users can select tables (e.g. Device Neighbor Table or Topology Table) to build the table for neighbors, which determines how the corresponding neighbors are discovered. The Device Neighbor Table shows the neighbors are discovered from a table parsed from the command results of hub devices. The Topology Table is for selection of one of the topology types to build the neighbor table.

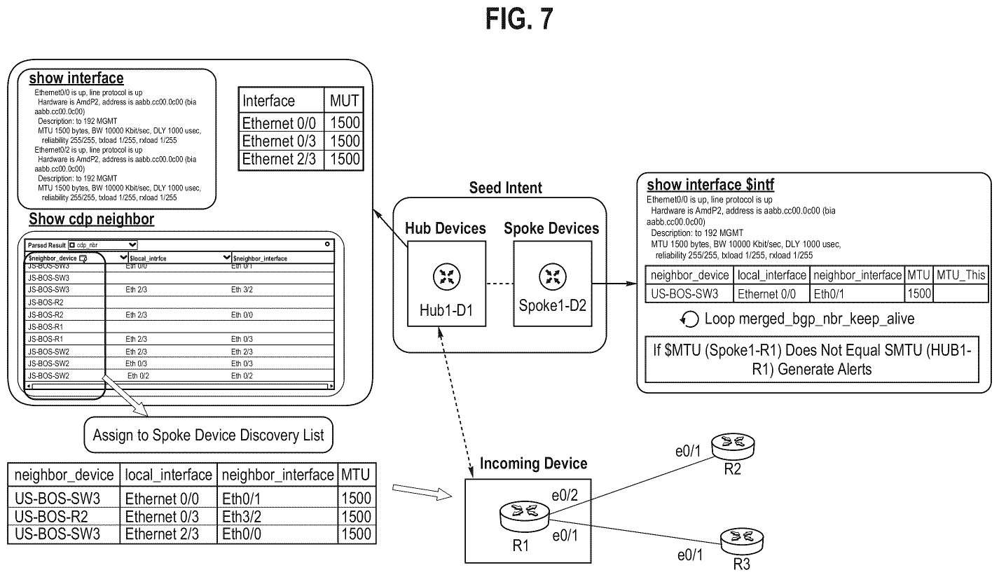

FIG. 7 illustrates replication of intent for neighbor devices. The system replicates the intent for the neighbor devices as follows: 1) Qualify Devices; 2) Decode Hub Devices; 3) Discover Spoke Devices; 4) Decode Spoke Devices; and 5) Replicate Intent. For the Qualify Devices, the device qualification may be defined in NIT is used to match the hub devices but not to match spoke devices. With “R1” as an incoming device, it may check the NIT's qualification and see whether it matches the definition. For the Decode Hub Devices, the hub devices are decoded automatically. With “R1” as an incoming device, it may use Hub1-D1 to see whether Hub1-D1 matches and can be used to decode “R1”. For the Discover Spoke Devices, if the hub devices are successfully decoded, their corresponding spoke devices will be discovered according to the decoding results of the hub devices. As “R1” is matched with the hub device, users may use the command “show cdp neighbor” to find 2 neighbors for the spoke device (“R2” and “R3”). For the Decode Spoke Devices, if spoke devices are successfully discovered, they will be decoded. The hub device and its spoke device exist in pairs, forming a dependency relationship. With “R2” and “R3” discovered as spoke devices, they may both be used to match Spoke1-D2 to see whether there's a match. The spoke parameters (e.g. show interface $interface) are replaced with the real value used in the cdp neighbor. For the Replicate Intent, the logic of diagnosis in seed intent will be replicated.

### Intent Library

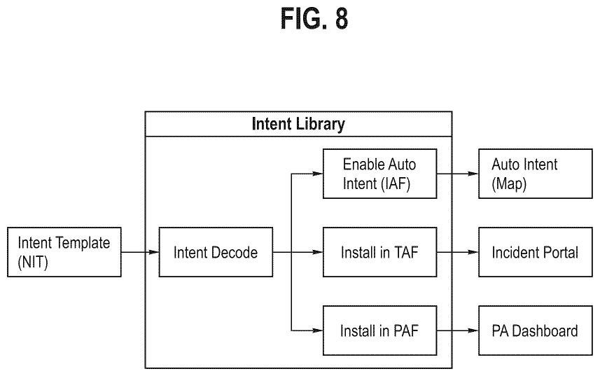

FIG. 8 illustrates an example intent library process. The intent library is a central console for these operations. The NIT can be fed into the intent library. Within the intent library, there may be an intent decode for the installation into the TAF and/or PAF. Auto intent may also be enabled. The Auto Intent can be created on a map to troubleshoot a network issue interactively. An incident portal may be used for the TAF, and the PA dashboard may be used for the PAF. This process is further discussed below.

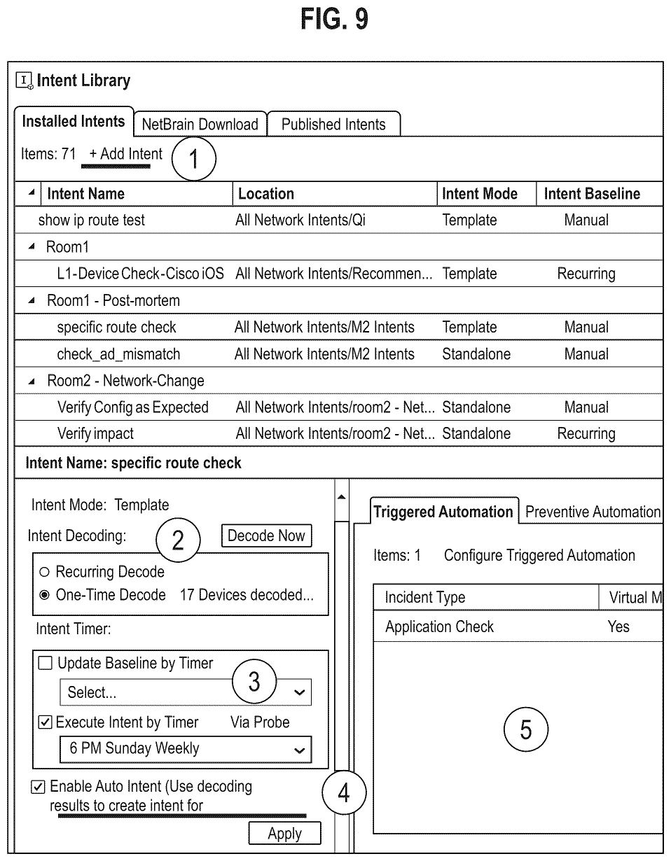

FIG. 9 illustrates an example console for intent installation. The Intent Library may include an Installed Intents tab with options for the installation. In the first box, an intent may be added as a standalone or as a template. There may be an Intent name, a location, an intent mode (e.g., standalone/template), an intent baseline (e.g., manual or recurring), an intent decoding time, an indication of auto intent, an indication of cloned intents, an indication of triggered automations, and/or an indication of preventative automations. The Intents may be grouped, such as by room shown in the example of FIG. 9.

In the second box, there may be a configuration for intent decoding. The intent decoding can be configured if the intent is installed as a template. A user can select one-time or recurring decoding as an example option. The NIT decoding service may create a list of qualified devices based on the NIT setting. These qualified devices may be used to clone NIs in real time.

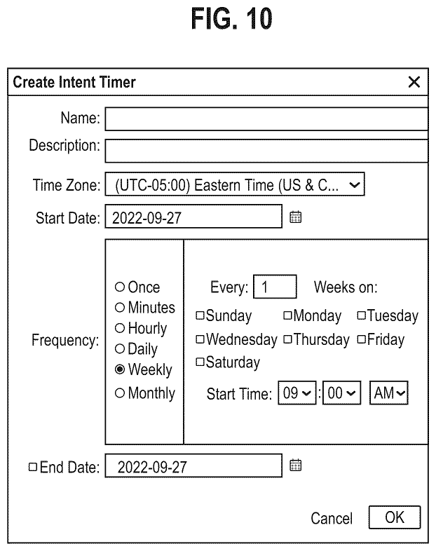

In the third box, intent timers may be configured. The option allows for the configuration of the timer to update the intent baseline and execute the Intent. The execution timer may be used by PAF, which may have two options: 1) Execute by Timer (always execute when the timer is up) and 2) Execute via Probe (when the condition of Probe is satisfied). FIG. 10 illustrates the configuration of intent timers as in the third box of FIG. 9. The user can create the intent timer frequency, as shown in FIG. 10.

In the fourth box of FIG. 9, the auto intent may be enabled. The enabling auto intent may allow the intent decode service to clone intents for the map. In the fifth box, a user can select to install NI/NIT to PAF and TAF.

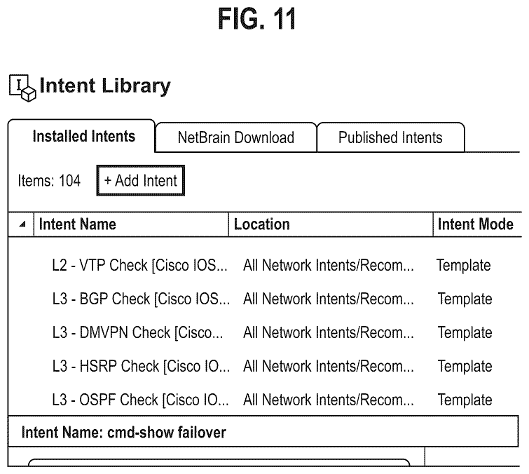

FIG. 11 illustrates addition of intent. For intent installation, the intent may be added in Standalone Mode or Template Mode, as shown in the Intent Mode of FIG. 9. Within the Intent Library, a user can select “+Add Intent” to open a dialog box for selecting an intent to install. In the Add Intent dialog box, a user may define basic information for the added Intent. The basic information may include the Network Intent, a group for the Intent, and/or a mode for the Intent. In the Network Intent field, a user can click Browse, then select the Intent to be added in the Select Network Intent dialog box.

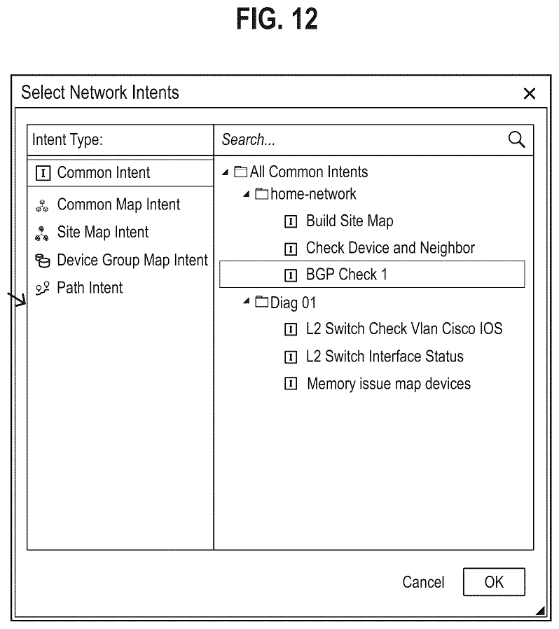

FIG. 12 illustrates a selection of the intent. In the Group field, a user can select a group for organizing the Intent to be added to the intent library. If the user does not select a group, the Intent may be placed in the built-in default group. Alternatively, the user can create a new group to organize the newly added Intent. In the Intent Mode field, the user can select a mode for the Intent (such as either Template or Standalone). The template may be selected by default. For a newly installed NI/NIT, the user can further define the configurations of the NI/NIT in the intent details pane.

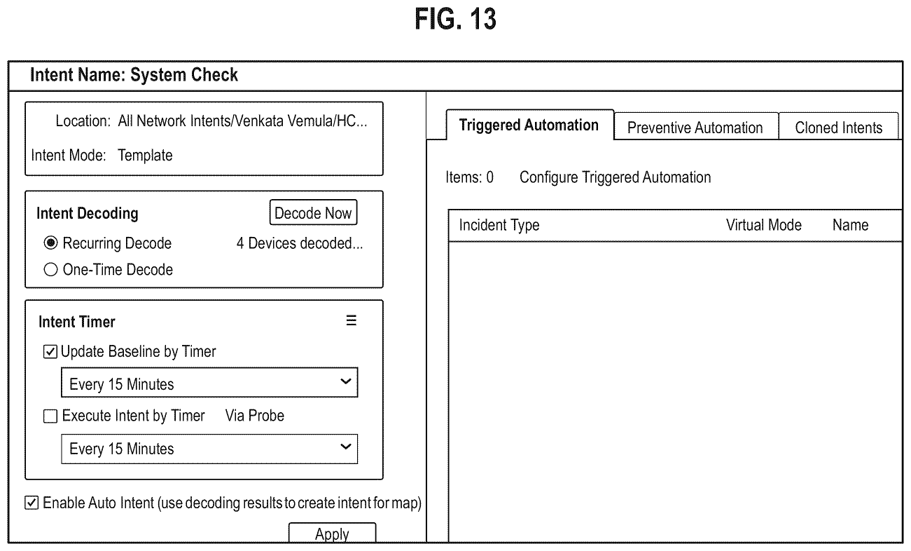

FIG. 13 illustrates the configuration definition with an intent details pane. The NI/NIT can be further configured in the pane shown in FIG. 13, which may be a partial view of the interface shown in FIG. 9. Specifically, a user can further Configure Intent Decoding, Configure Intent Timer, and/or Enable Auto Intent. After selecting the options for the configuration of the NI/NIT, the user can click Apply at the bottom-right corner of the left pane to apply the settings. Configuration of the intent decoding may be used when the Intent is installed as a template. The user can select one-time or recurring decoding. The NIT decoding service tests whether an NI can be cloned for a device based on the NIT setting and creates a list of devices from which the system can clone the NI. However, the decoding service may not create the NIs for these devices. Rather, the NIs will be created when TAF and PAF trigger the Intent or users create the Intent manually from the auto intents.

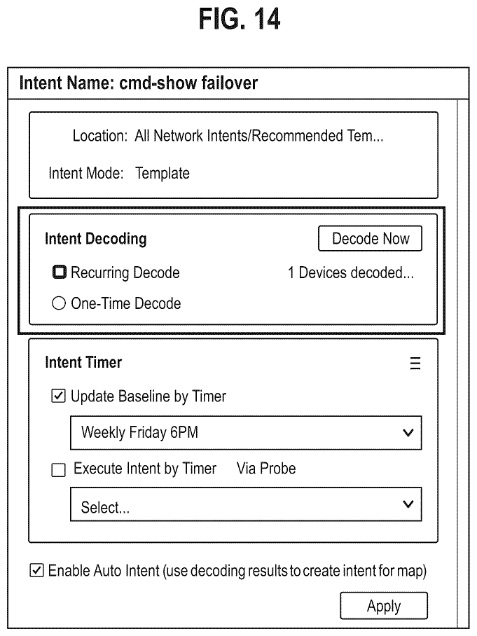

FIG. 14 illustrates an example of intent decoding settings. Example decoding modes include:
Recurring Decode: The baseline data of the devices of the NIT will be decoded regularly at the frequency of the setup Timer for this NIT.
One-Time Decode: The baseline data of the device of the NIT is decoded once according to the setup Timer for this NIT.
   The user can select the Click Decode Now button to have the system decode the Intent immediately or the system may send the decoding task to a queue.

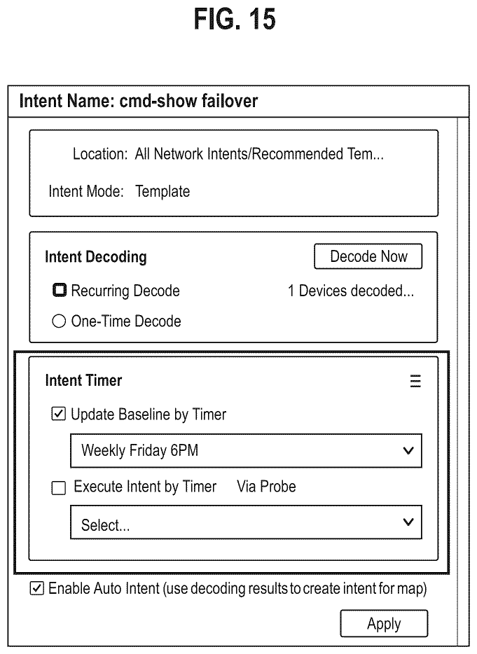

FIG. 15 illustrates an example of intent timer settings. The intent timer is a setting to control the frequency of decoding baseline data of devices for Intent and executing Intent. The user can configure when to update the baseline and execute the Intent via the Intent Timer. The intent timer can be selected for decoding baseline data. The user checks the Update Baseline by Timer check box, and selects an intent timer for the selected Intent from all the intent timers in the system listed in the drop-down list. Further, the user can enable via probe by selecting the Via Probe checkbox. If a preventive automation probe is set up for the Intent, it can enable the Probe to trigger the intent execution when selecting the intent timer for intent execution. The execution of the target intent will be scheduled by the intent timer and triggered by the associated Probe. To enable the Via Probe function, the user checks the Execute Intent by Timer checkbox. Finally, the user can enable Auto Intent. After decoding an intent template, the user can clone and execute the Intent on a map if any device in the map is qualified. The Intent and qualified devices are listed under the auto intent pane in the map. Before an Intent can be part of Auto Intents, it may need to be enabled through the auto intent function. At the bottom of FIG. 15 is a check box for enabling auto intent functionality.

### Auto Intent

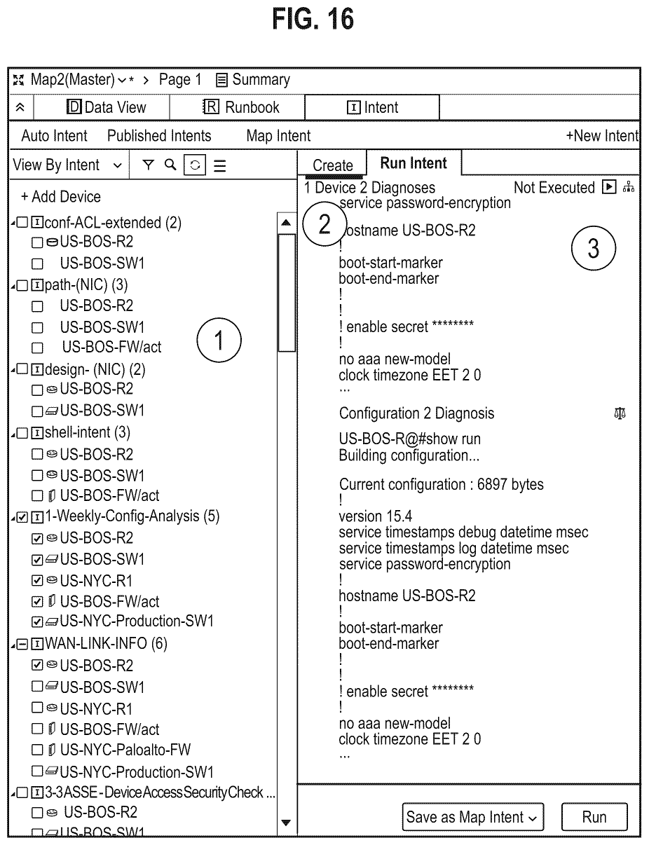

When users open a map, the automatically decoded Intents for the map devices are listed under the Auto Intents by device or Intent. Users can select one or multiple auto intents. FIG. 16 illustrates an example of auto intent settings.

A user can select and view Auto Intent in the first box. This will allow for the creation or recreation of the selected intents. The intent decoding services (configured in the Intent Library) may not create the intents. Instead, the auto intents may be created in the second box. Specifically, the created auto intents may be selected and run from the third box. The results can be viewed in a post-execution Diagnosis Tree.

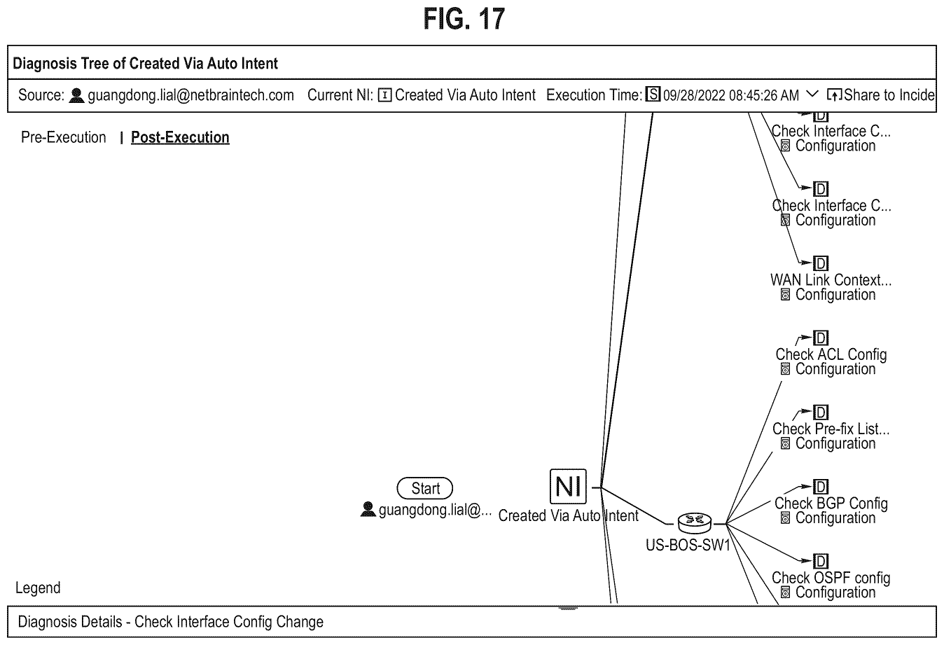

FIG. 17 illustrates an example of a post-execution diagnosis tree. The diagnosis tree may be created via auto intent post execution. The map shown is an example post-execution diagnosis tree.

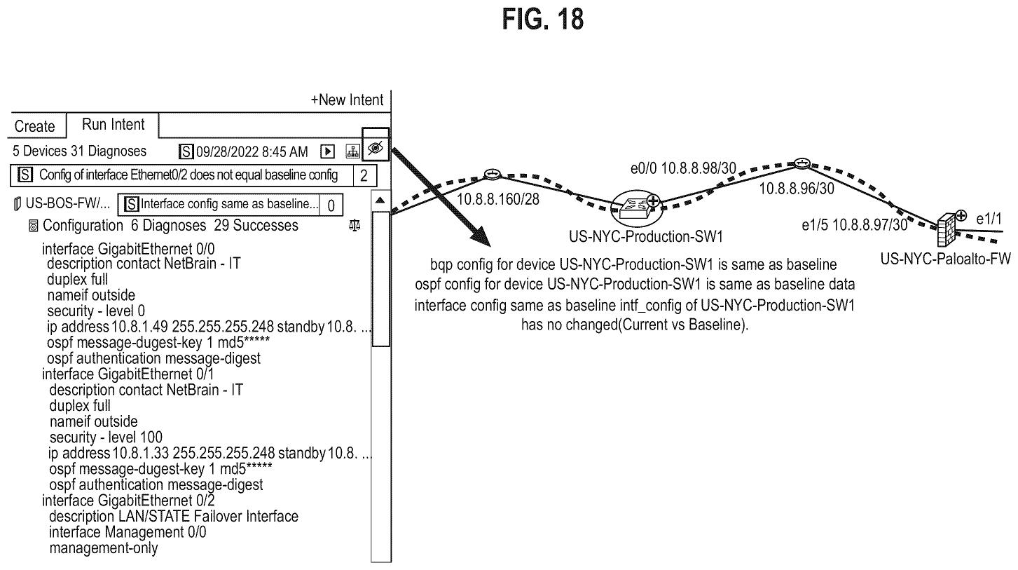

FIG. 18 illustrates an example view of the map. This display may include the results viewed on the map in a special data view. As shown, a user can change the running from the third box of FIG. 17 for this special view, which provides a different display of the map.

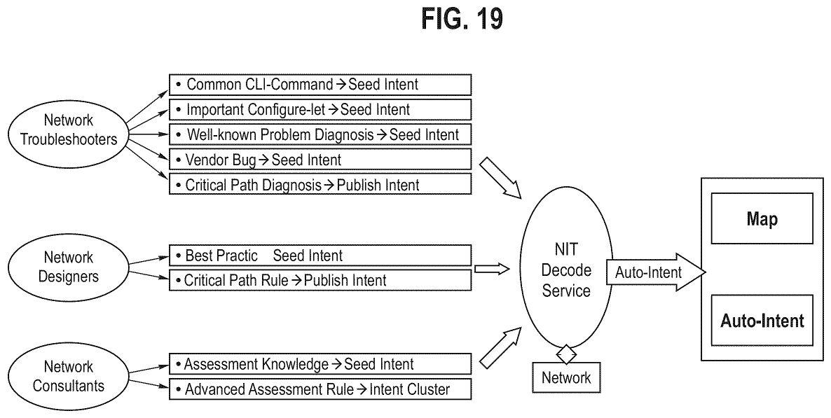

FIG. 19 illustrates the scaling of auto intent. A number of inputs may be received by the NIT decode service, which provides the Auto Intent for the resulting map and Auto Intent generation. The inputs may be from network troubleshooters, network designers, and/or network consultants and may include Intent to see the service, published intent, and/or an intent cluster. The NIT (e.g., easy to clone NI) Auto Intent decoding service and the corresponding Auto Intent can scale intents to a large network without significant user intervention.

### Triggered Automation Framework (TAF)

Triggered Automation Framework (TAF) is a framework for an incident such as a ServiceNow ticket to trigger the related network automation such as Network Intent and Runbook.

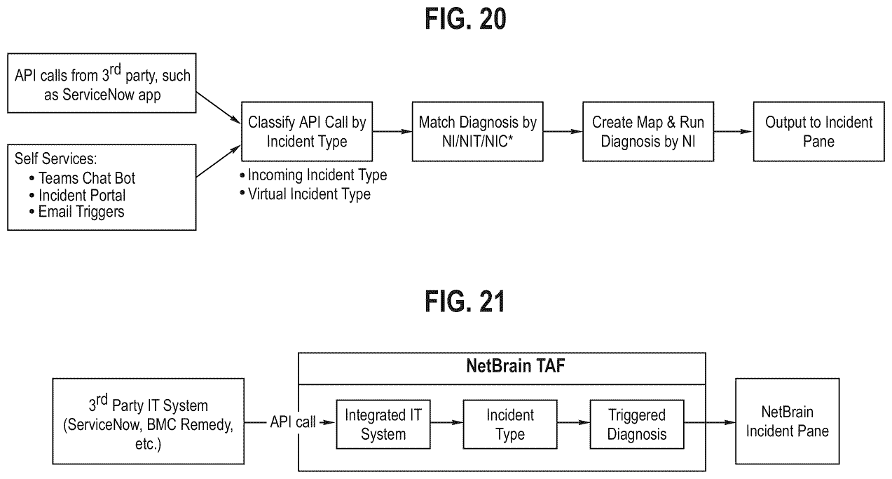

FIG. 20 illustrates an example Triggered Automation Framework (TAF) framework. The triggered Automation (TAF) is a framework to connect the Automation (NI/NIT/NIC) with a network problem by the following example steps:
Receive the API calls from 3rd party system or the self-service application (e.g., team chatbot, emails, and Incident Portals);
Classify the call to an Incident Type;
Match the standalone NI or member NIs with the static data field of the API call (static diagnosis) or the hash tags (dynamic diagnosis);
Execute NIs to create the map and/or run the diagnosis; and
Output the maps and diagnosis results to the Incident Portals.

FIG. 21 illustrates another example Triggered Automation Framework (TAF) process. In some embodiments, TAF has the following components: 1) Integrated IT System; 2) Incident Type; and 3) Triggered Diagnosis. For the Integrated IT System, the categories of API calls are defined along with what data for each API call comes from the IT system (ticket system) to be integrated with the system. For the Incident Type, each category of the incoming API call from the Integrated IT Systems is classified into Incident types. The Incident Type may include: a) The condition to put an API call into this Incident Type; b) The signature to decide whether to merge the API call into an existing Incident or create a new Incident; and/or c) The Incident message and Guidebook, which will be displayed in the Incident Pane. For the Triggered Diagnosis, each Incident Type can be installed to execute NI/NIC. The installed NI and NIC can be run automatically (triggered Diagnosis) by the incoming API call or displayed in the Incident Pane for the user to execute manually (self-service). The Diagnosis results and NI codes may be shown in the Incident Pane and the Integrated IT system. The Triggered Diagnosis may include: a) When to trigger run NI/NIC (triggered condition); b) Which member NIs for a NIC (member Network Intent filter); and/or c) How to run a member NI (member NI execution mode). Users can select Create the Intent Map, Execute the NI, or both.

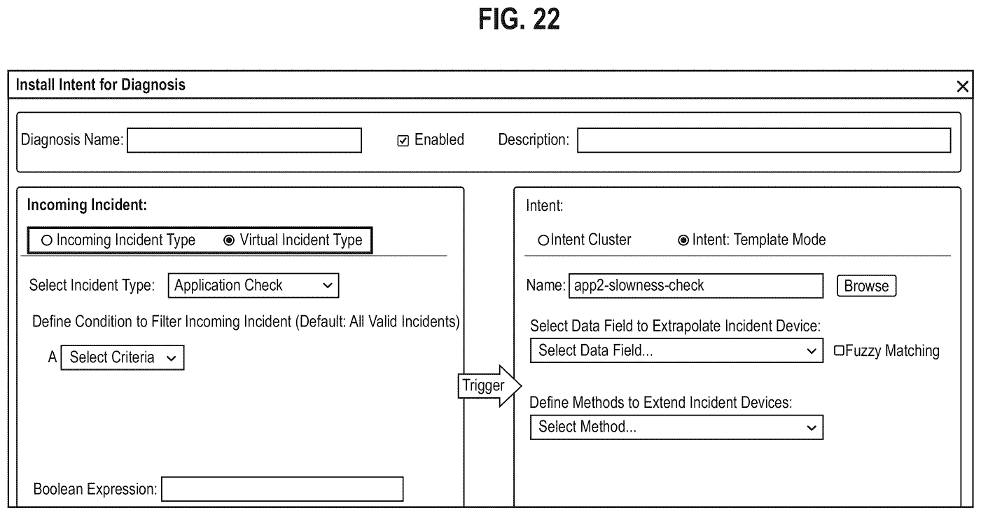

FIG. 22 illustrates an example intent library interface. The NI/NIT/NIC can be installed in incident types with an interface from the Intent Library. The Intent may be installed for diagnosis. The incoming incident type may be virtual. There may be selectable criteria for defining the conditions to filter the incoming incident.

### Preventative Automation Framework (PAF)

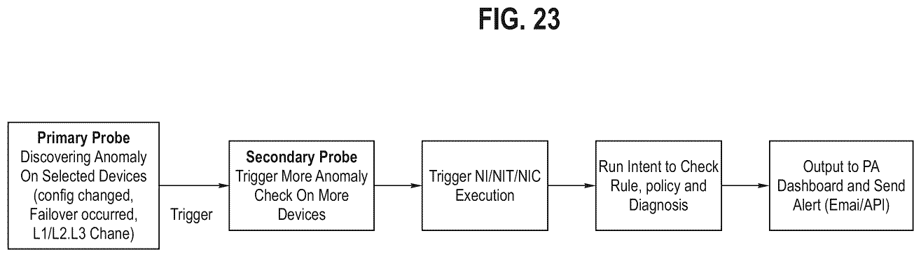

Preventative Automation Framework (PAF) is a framework using two-level probes (primary and secondary probes), which can further trigger any NI/NIT/NIC execution. FIG. 23 illustrates an example Preventative Automation Framework (PAF) process. A primary probe is used for discovering an anomaly on selected devices. The anomaly may include a configuration change, a failover, or a layer (i.e.,, L1/L2/L3) change. The primary probe may trigger the secondary probe which triggers more anomaly checks on additional devices. This may trigger NI/NIT/NIC execution and the running of an intent to check rules, policy, and diagnosis. The output is provided to a PA dashboard, and alerts may be provided.

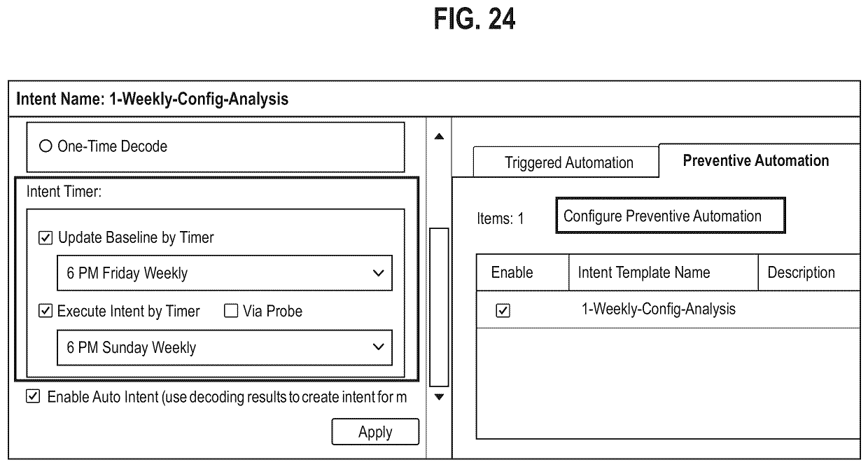

FIG. 24 illustrates an example intent timer configuration for preventative automation (PA). Users can configure the timer to execute the Intent for PAF, which may have two options: Execute by Timer (always execute when the timer is up) and Execute via Probe (when the condition of Probe is satisfied).

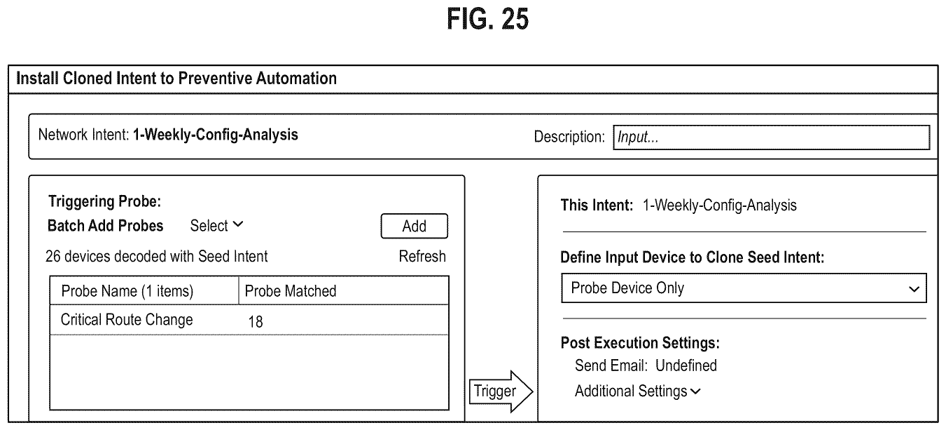

FIG. 25 illustrates an example interface for probe triggering. Users can add probes to trigger this Intent in the Intent Library and define the input devices to clone the seed intent.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for network intent replication, the method comprising:
defining an intent template comprising criteria for qualifying devices;
enabling a backend decoding service for the qualifying devices compared with the intent template;
updating baseline data based on the backend decoding service; and
creating and executing intents for the qualified devices in a map.

2. The method of claim 1, wherein the intent template is configured for further:
defining the qualifying devices;
filtering the defined devices by device group or groups;
defining critical variable settings based on a selection of diagnosis variables; and
defining, depending on network intent (NI), macro variables.

3. The method of claim 2, wherein the critical variable settings are established by an output of CLI or SNMP commands.

4. The method of claim 3, further comprising:
selecting diagnosis variables by default; or
selecting diagnosis variables manually with a subset of variables.

5. The method of claim 2, wherein the critical variable settings are established by an output of an API call.

6. The method of claim 2, further comprising:
cloning network intent (NI) for the qualifying devices; and
cloning NI for other devices users add.

7. The method of claim 2, further comprising: cloning the intent for the devices of an application path.

8. The method of claim 2, further comprising: cloning the intent for the neighbor devices if the intent includes the diagnosis across the devices.

9. The method of claim 2, further comprising:
creating a member network intent (NI) for a device when critical variables are retrieved and parsed successfully.

10. The method of claim 1, further comprising:
providing a map pane in the map displaying the decoded intents and their qualified map devices.

11. The method of claim 1, further comprising:
selecting an intent and a subset of qualified map devices, cloning the intent for these devices, executing the cloned intent, and displaying the intent results in the map.

12. A system comprising:
an intent template configured to qualify devices;
a backend decoding service configured to qualify the devices based on the intent template and to update baseline data; and
creating and executing intents for the qualified devices in a map.

13. The system of claim 12, wherein the intent template comprises:
definitions of the devices that qualify;
a filter for the defined devices by device group or sites;
critical variable settings for the selection of diagnosis variables;
macro variables for network intent (NI); and
a reference map creation.

14. The system of claim 13, wherein the critical variable settings are established by an output of CLI or SNMP commands.

15. The system of claim 14, wherein the diagnosis variables are selected by default or selected manually from a subset of variables.

16. The system of claim 13, wherein the critical variable settings are established by an output of an API call.

17. The method of claim 12, further comprising: cloning the intent for the devices of an application path.

18. The method of claim 12, further comprising: cloning the intent for the neighbor devices if the intent includes the diagnosis across the devices.

19. The system of claim 12, further comprising:
a network intent that is cloned for the devices that qualify or for other devices users add.

20. The system of claim 12, further comprising:
a cloned network intent (NI) for a device when critical variables are retrieved and parsed successfully.

21. The system of claim 12, further comprising:
a map pane in the map displaying the decoded intents and qualified map devices.

22. The system of claim 21, wherein an intent and a subset of qualified map devices is selected, and the intent for these devices is cloned and executing, further wherein the intent results are displayed in the map.

23. A method for a triggered automation (TAF), the method comprising:
receiving API calls from a third party system or a self-service application;
classifying the calls to an Incident Type;
matching a standalone network intent (NI) or an intent template (NIT) with a data field of the API call;
executing NIs to create a map or run a diagnosis; and
outputting the maps and diagnosis results to an Incident Portal.
